(19) United States
(12) Patent Application Publication
(10) Pub. No.: US 2006/0078858 A1
(43) Pub. Date: Apr. 13, 2006

(54) Device and method for evaluation of reading speed to determine vision problems

(76) Inventors: David T. Vroman, Charleston, SC (US); Kerry D. Solomon, Sullivans Island, SC (US)

Correspondence Address: SUGHRUE MION, PLLC, 2100 PENNSYLVANIA AVENUE, N.W., SUITE 800, WASHINGTON, DC, 20037, US

(21) Appl. No.: 10/949,227

(22) Filed: Sep. 27, 2004

(51) Int. Cl. G09B 17/04

(52) U.S. Cl. 434/179

(57) ABSTRACT

An illustrative method of assessing a vision characteristic of a person is provided. In the method, a group of words is presented via a medium, and a person reads the group of words. Also, the reading speed at which the person reads the group of words is determined, and the vision characteristic of the person is assessed based on the reading speed. Also, an illustrative apparatus assessing the vision characteristic is provided. In the apparatus, an input circuit generates a reading speed signal corresponding to the reading speed at which the person reads the group of words from the medium. Then, a control circuit determines the vision characteristic based on the reading speed.

### FIELD OF THE INVENTION

An illustrative, non-limiting embodiment of the present invention relates to a device and method that evaluates a person's vision. A more specific illustrative, non-limiting embodiment of the present invention relates to a device and a method that analyzes the ability of a person to view close objects by determining the person's ability to read small print quickly and accurately under various conditions of light and contrast. In a further, non-limiting implementation of the invention, the device and method measure the functional reading vision of people who have had, or who need, any type of correction for presbyopia or farsightedness.

### BACKGROUND OF THE INVENTION

In the optical system of the eye, the crystalline lens is responsible for approximately one third of the eye's focusing ability. The crystalline lens is a dynamic structure that provides additional focusing power when a person looks at an object that is close to the eye. The process of providing this additional focusing power is known as “accommodation.” As a person ages, the ability of the crystalline lens to perform the accommodating function diminishes, and this loss of ability is known as “presbyopia.” This diminished ability is inevitable in all humans and begins around the age of 40.

A person, who has perfect vision with a young lens that functions normally, can clearly see objects that are close to the eye, as well as objects that are far away from the eye. On the other hand, a person who can see objects that are close to the eye more clearly than objects that are far from the eye is “nearsighted” or “myopic.” Conversely, a person who can see objects that are far from the eye more clearly than objects that are close to the eye is “farsighted” or “hyperopic.” Nearsighted people and farsighted people are “ammetropic” and need a lens (e.g., a contact lens or a spectacle lens) to help refract light in order to see an object clearly.

An individual may suffer from nearsightedness or farsightedness before he or she suffers from presbyopia. For example, a person may be nearsighted before he or she becomes thirty years old and may begin suffering from presbyopia after reaching the age of forty years old. Also, a person's loss of accommodation slowly progresses over the next twenty to thirty years until there is no accommodation at all.

In the example above, the person will have his or her nearsightedness or farsightedness corrected via glasses, contact lenses, or surgery. However, when the person subsequently begins to suffer from presbyopia, his or her difficulty in reading or focusing on an object that is close to the eye must also be corrected.

Currently, many techniques exist to correct presbyopia. The most common technique is the use of a reading spectacle lens or bifocal spectacle lens that provides additional focusing power when a person is viewing an object that is close to the eye. Another technique is to create a “monovision” effect with contact lenses. The “monovision” effect results by using a first contact lens to optimally focus one eye for distance vision and by using a second contact lens to optimally focus the other eye for near vision. As a result of the “monovision” effect, the brain learns to rely primarily on one eye to view distant objects and to rely primarily on the other eye to view close objects. In addition to the above techniques, a person can use multifocal or bifocal contact lenses that allow him or her to view close objects and distant objects.

Although the above techniques cure ammetropia and presbyopia, many people do not like the inconveniences that stem from having to wear glasses or contacts. Thus, in recent years, many people who are more than forty years old have undergone eye surgery to improve their ability to see objects that are both close and far away.

For example, various corneal refractive surgeries, such as laser in situ keratomilieusis (“LASIK”), photorefractive keratectomy (“PRK”), radial keratotomy (“RK”), conductive keratoplasty (“CK”), and intrastromal rings (“INTACS”), can be used to create the “monovision” effect discussed above. Also, intraocular lenses can be chosen to create the “monovision” effect after the patient's crystalline lens is removed during a clear lensectomy or cataract surgery.

More recent techniques have been created which attempt to restore the function of the crystalline lens without compromising distance vision. These techniques include several variations of surgical reversal of presbyopia (“SRP”). In SRP, surgery is often performed in the sclera, which is the tough white fibrous outer envelope of tissue that covers the entire eyeball except for the cornea and which is located just inside the limbus.

Currently, there is a significant interest in correcting presbyopia by using intraocular lenses, which are implanted after the crystalline lens is removed. One type of intraocular lens is designed to actually perform the accommodating function by moving to an appropriate position when a person attempts to view a close object or read fine print. Another type of intraocular lens is a “pseudo-accommodative” lens, which does not move, but which constantly refracts light onto the retina when a person is viewing both close objects and distance objects.

While there are many techniques for correcting presbyopia, there are only a limited number of ways to diagnose such problems and determine the appropriate type of correction, as well as the proper amount of correction, for the problems. The most common method for evaluating a person's level of presbyopia is to assess his or her ability to read rows of individual letters. This test is typically accomplished by using a “Jaeger” card, which has black letters on a white background. To perform the test, the person holds the Jaeger card at an optimum reading length and reads the letters. Then, based on the number of letters that the person correctly reads, the person's visual acuity is measured and rated on a scale of J1, J2, J3, J4, etc. The rating of J1 indicates the best visual acuity.

In addition, a doctor may test a person's visual acuity by projecting charts in a viewing box that assesses near vision. This test also uses individual letters and rates a person's visual acuity based on how well he or she can read the letters.

Another test uses a card that contains several sentences, and the doctor determines the person's visual acuity based on how well the person reads the sentences. However, this test is typically used in low vision evaluations and does not assess a person's functional reading accuracy or speed.

In addition, none of the testing methods described above truly indicates how well a person can view objects that are close to the eye. For example, a person may be able to read small letters well but cannot read words, sentences, or paragraphs quickly and accurately. For instance, a person who undergoes SRP with scleral expansion bands will likely be able to read very small letters and may score a “J2” on the Jaeger scale, which suggests that the person can read letters that are smaller than the average newspaper print. However, such a person may not be able to read a word in a newspaper. Thus, the Jaeger test would indicate that the person could see small objects very well, but the person's vision would not allow him or her to read at a functional level.

One reason why the Jaeger test does not accurately indicate a person's ability to read small print is due to the fact that, in the real world, a person views things under a wide range of conditions and for various purposes. For example, people commonly encounter low lighting conditions, low contrast, and intense glare when they try to view small objects closely or try to read fine print. The Jaeger test does not take into account the various circumstances and actual conditions surrounding a person's ability to view objects close to the eye.

### SUMMARY OF THE INVENTION

Illustrative, non-limiting embodiments of the present invention overcome the disadvantages described above and other disadvantages. Also, the present invention is not required to overcome the disadvantages described above and the other disadvantages, and an illustrative, non-limiting embodiment of the present invention may not overcome any of the disadvantages.

One illustrative, non-limiting embodiment of the present invention relates to a method of assessing a vision characteristic. In the embodiment, the method comprises: (a) presenting at least a first group of words via a medium; (b) determining a reading speed at which a person reads at least the first group of words from the medium; and (c) assessing the vision characteristic based on the reading speed.

Another illustrative, non-limiting embodiment of the present invention relates to an apparatus for assessing a vision characteristic. In the embodiment, the apparatus comprises: an input circuit that generates a reading speed signal corresponding to a reading speed at which a person reads at least a first group of words from a medium; and a control circuit that determines the vision characteristic based on the reading speed.

### BRIEF DESCRIPTION OF THE DRAWINGS

Aspects of illustrative, non-limiting embodiments of the present invention will become more apparent by describing in detail embodiments thereof with reference to the attached drawings in which:

FIG. 1 shows an illustrative example of a first group of words, a second group of words, and a third group of words in accordance with a non-limiting embodiment of the present invention;

FIG. 2 shows an illustrative example of a non-limiting embodiment in which the groups of words shown in FIG. 1 are part of a book or sheets of paper;

FIG. 3 shows an illustrative example of a non-limiting embodiment in which the groups of words shown in FIG. 1 are displayed on a screen or a wall via a projector;

FIG. 4 shows an illustrative example of a non-limiting embodiment in which the groups of words shown in FIG. 1 are displayed in a viewing box;

FIG. 5 shows an illustrative example of a non-limiting embodiment in which the groups of words shown in FIG. 1 are displayed on a display of a computer;

FIG. 6 shows an illustrative, non-limiting embodiment of an apparatus that determines a person's functional reading speed; and

FIG. 7 shows an illustrative, non-limiting embodiment of a look up table that the apparatus shown in FIG. 6 uses to determine a person's functional reading speed.

### DESCRIPTION OF ILLUSTRATIVE NON-LIMITING EMBODIMENTS OF THE INVENTION

The following description of illustrative non-limiting embodiments of the invention discloses specific configurations and components. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations and components of the present invention that are known to one skilled in the art are omitted for the sake of clarity and brevity.

On a day-to-day basis, most people rely on their vision for reading. Reading is one of the most important activities that people perform at work, home, and elsewhere. An illustrative, non-limiting embodiment of the present invention assesses a person's vision in terms of the quality and functionality of the person's ability to clearly view words and sentences and read them. This type of vision will be referred to as “functional reading vision.”

In one example, a person reads multiple groups of words (e.g., random words, phrases, sentences, or paragraphs), and some or all of the groups of words may have different characteristics. For example, the various groups of words may have different font types (e.g., a “Times New Roman” font type or a “Courier New” font type), different font sizes (e.g., a nine-point font size or a twelve-point font size), different font styles (e.g., an “all-uppercase” font style, an “all-lowercase” font style, a “sentence-case” font style, an italicized font style, a bolded font style, or an underlined font style), different spacing (e.g., single-spaced lines or double-spaced lines), different font colors or shades, and different background colors or shades to create different contrast levels. In an alternative implementation, all of the groups of words have the same characteristics.

When the person reads the groups of words, the speed at which the person is able to read the groups of words is measured, and the accuracy with which the person reads the groups of words is determined. Then, as described in more detail below, the speed and accuracy of the person's reading ability, as well as other factors, may be used to determine the patients functional reading vision.

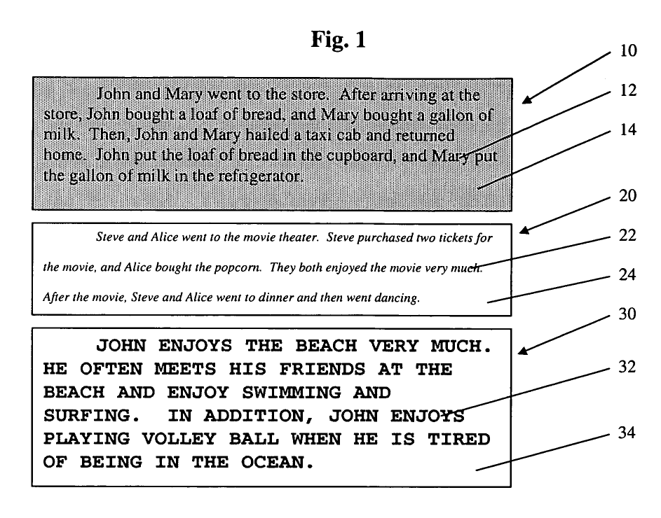

FIG. 1 shows an example of a page having a first group of words 10, a second group of words 20, and a third group of words 30. Although the example in FIG. 1 shows multiple groups of words 10 on a single page, each of the groups of words 10, 20, and 30 may be provided on a different page, or one of the groups of words 10, 20, and 30 may span more than one page.

In any event, in the present example, the first group of words 10 has words 12 that are written on a yellow background 14. Also, the words 12 have a “Times New Roman” font type, have a twelve-point font size, have a “sentence-case” font style, are single-spaced, and have a black font color.

The second group of words 20 has words 22 that are written on a white background 24. Also, the words 22 have a “Times New Roman” font type, have a nine-point font size, have “sentence-case” and italicized font styles, are double-spaced, and have a black font color.

The third group of words 30 has words 32 that are written on a white background 34. Also, the words 32 have a “Courier New” font type, have a fourteen-point font size, have “uppercase” and bolded font styles, are single-spaced, and have a red font color.

Clearly, the font sizes, colors, and background contrasts described above are illustrative for the purposes of generally conveying aspects of a non-limiting embodiment of the invention. Of course, the actual characteristics for the groups of words may be determined, adjusted, and optimized based on the specific circumstances surrounding the vision test. In one implementation, the optimal characteristics may be empirically determined and adjusted as people skilled in the art discover which characteristics and combinations of characteristics provide better diagnostic results.

The subject matter of the groups of words 10, 20, and 30 are not related to each other. However, one skilled in the art will readily realize that the subject matter of all or some of the groups of words 10, 20, and 30 may be related to each other. In addition, while FIG. 1 shows only three groups of words 10, 20, and 30, clearly more than three groups may be used. In fact, in one implementation, the number of groups of words, the length of each group, and number of words within each group are determined to allow statistically accurate assessment of the reading speed of a person. Therefore, in certain implementations, the groups of words 10, 20, and 30 may span multiple pages and may contain more than three groups.

In addition, in order to prevent racial, social, economic, educational, and other statuses of a person, who reads the groups of words 10, 20, and 30, from adversely influencing the accuracy of the test, the groups of words 10, 20, and 30 may contain subject matter that is familiar to many different people from a wide range of backgrounds. Alternatively, the subject matter of one set of groups of words may be tailored for people having a first racial, social, economic, educational, and/or other status, and the subject matter of another set of groups of words may be tailored for people having a second racial, social, economic, educational, and/or other status.

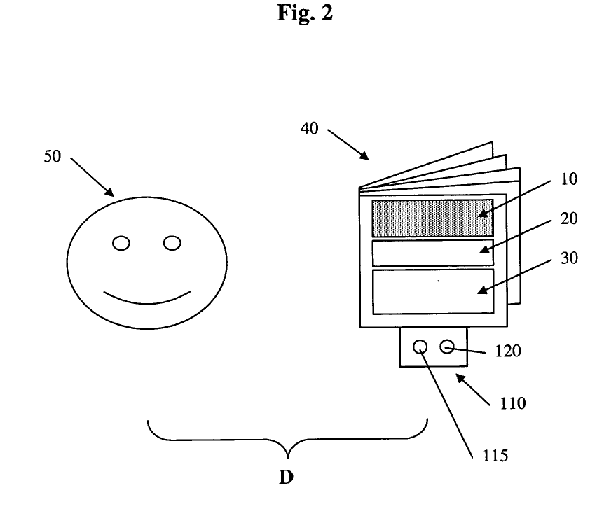

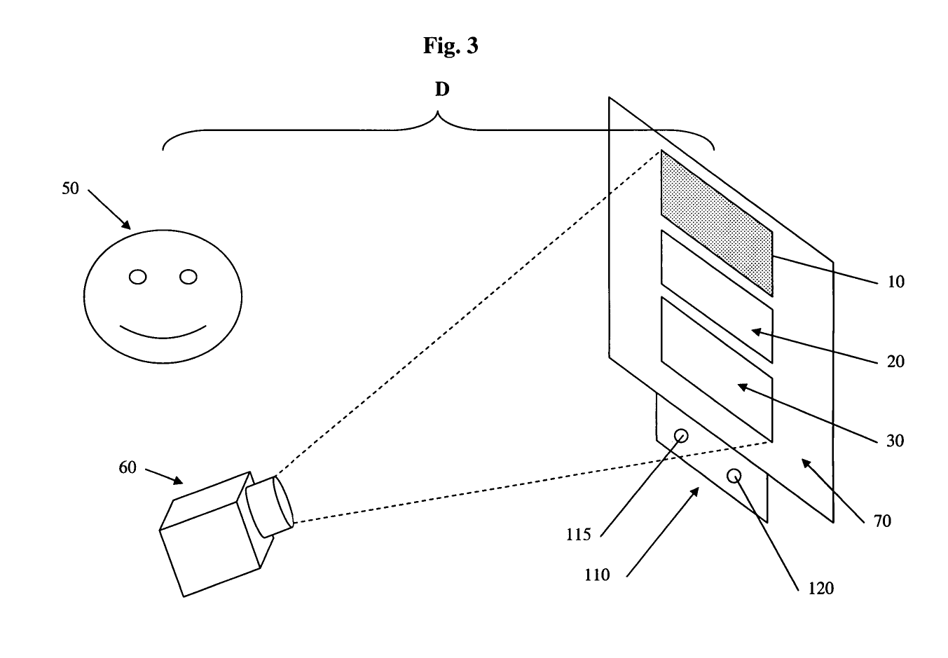

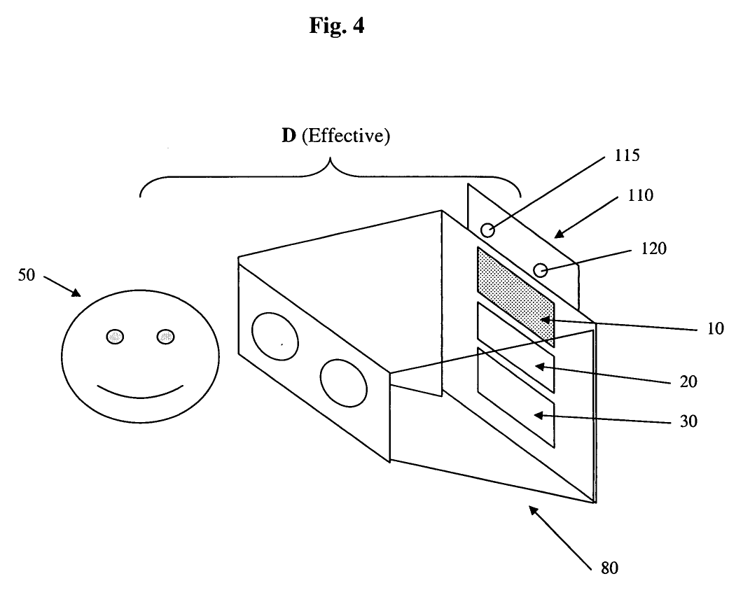

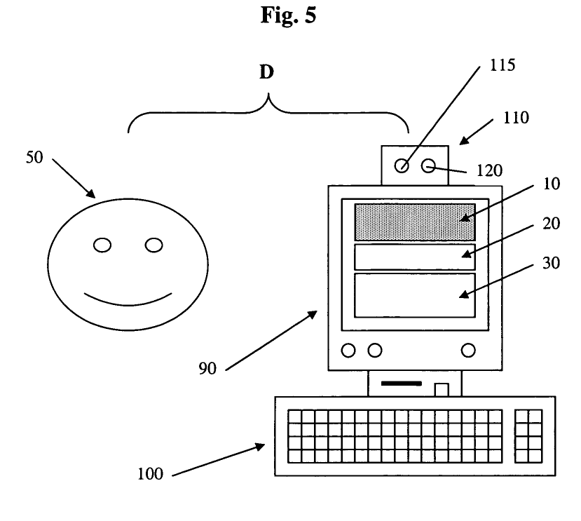

Turning back to the present example, the groups of words 10, 20, and 30 can be presented in virtually any format and can be presented by virtually any type of media that allows the person being tested to read the groups of words 10, 20, and 30. For example, as shown in FIG. 2, the groups of words 10, 20, and 30 may be part of a book 40 or sheets of paper 40. On the other hand, as shown in FIG. 3, a projector 60 may project the groups of words 10, 20, and 30 on a screen 70 or wall 70, and the “pages” displayed on the screen 70 or wall 70 may correspond to electronic or actual slides that are sequentially displayed as the person 50 finishes reading each slide. Furthermore, as shown in FIG. 4, a viewing box 80 may present the groups of words 10, 20, and 30 to the person 50, and the “pages” displayed in the viewing box 80 may correspond to slides that are sequentially displayed as the person 50 finishes reading each slide. Also, as shown in FIG. 5, the groups of words 10, 20, and 30 may be displayed on a display 90 of a computer 100, and as in the case of the projector 60 or viewing box 80, the “pages” displayed on the display 90 may correspond to slides that are sequentially displayed as the person 50 finishes reading each slide.

In addition, as shown in FIGS. 2-5, the distance D between the eyes of the person 50 and the groups of words 10, 20, and 30 is a factor in evaluating the person's presbyopia. For example, if the person 50 is located at a first distance from the groups of words 10, 20, and 30, he or she may be able to accurately and quickly read the groups of words 10, 20, and 30. On the other hand, if the person 50 is located at a second distance from the groups of words, 10, 20, and 30, he or she may read the groups of words 10, 20, and 30 more slowly and/or with a greater number of errors.

The distance D (or effective distance D in the viewing box 80 (FIG. 4)) between the person 50 and the groups of words 10, 20, and 30 may be predetermined and held constant during the test. For example, a stationary support may hold the person's, head, face, or chin a predetermined distance D away from the group of words 10, 20, and 30.

In another implementation, the person 50 may be allowed to move himself or herself to change his or her distance D from the groups of words 10, 20, and 30. Alternatively or additionally, the person 50 may be able to change the position of the device presenting the groups of words 10, 20, and 30 (especially if the book 40 presents the groups of words 10, 20, and 30) to change the distance D. When the person is allowed to change the distance D, the distance D may be measured.

Virtually any type of device may be used to measure the distance D. For example, as shown in FIGS. 2-5, a distance sensing circuit 110 may be placed near the groups of words 10, 20, and 30. The distance sensing circuit 110 may comprises an infrared, laser, or other light emitting device 115 and an appropriate sensor 120. The light emitting device 115 emits a beam or a pulse of light, and the sensor 120 senses the beam or pulse after it reflects off of the person 50. The distance D between the person 50 and the groups of words 10, 20, and 30 can be determined based on the difference between the time at which the device 115 emits the light and the time at which the sensor 120 senses the light.

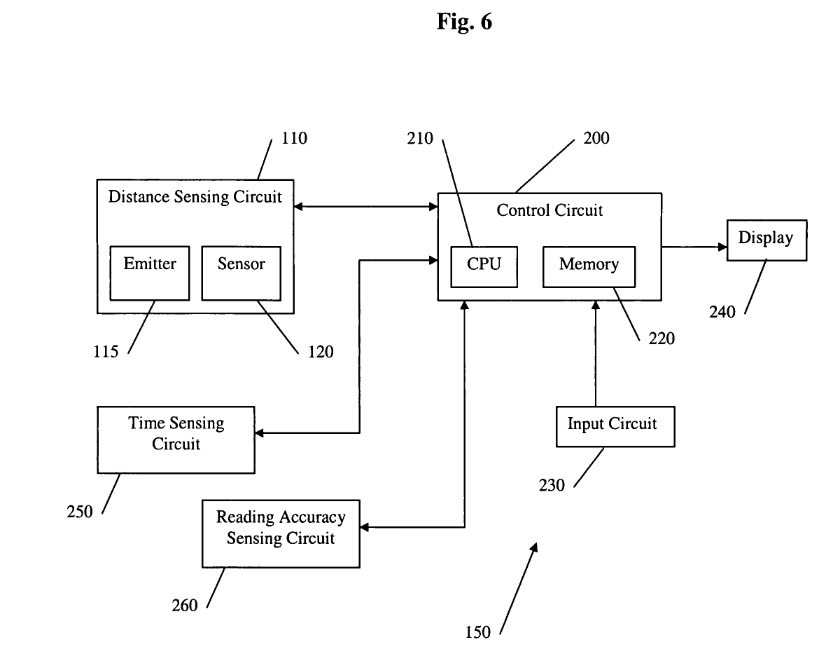

FIG. 6 shows an illustrative, non-limiting embodiment of an apparatus 150 that uses the distance sensing circuit 110 to determine the distance between the person 50 and the groups of words 10, 20, and 30. As shown in the figure, the apparatus 150 comprises the distance sensing circuit 110, a control circuit 200, an input circuit 230, and a display 240. The control circuit 200, which may constitute at least part of the computer 100 in FIG. 5, comprises, among other components, a CPU 210 and memory 220.

The memory 220 may comprise a random access memory (“RAM”), which is used as a working memory, and a read only memory (“ROM”), which stores an operating program that that controls the operation of the CPU 210. Also, the control circuit 200 may alternatively or additionally include other memories, such as a flash memory, a video RAM, an erasable programmable ROM (“EPROM”), a hard disk drive, a floppy disk drive (with a floppy disk), an optical disk drive (with an optical disk), a magneto-optical disk drive (with a magneto-optical disk), a universal serial bus (“USB”) drive (with a USB memory), a memory card reader (with a memory card), etc.

Also, the display 240 may be virtually any type of display that conveys visual information to the person 50. In a non-limiting example, the display 240 may comprise a cathode ray tube (“CRT”), a liquid crystal display (“LCD”), a plasma display, a light emitting diode (“LED”) display, a projector, etc. Also, the display 240 may comprise the projector 60 shown in FIG. 3, the viewing box 80 shown in FIG. 4, or the computer display 90 shown in FIG. 5.

To measure the distance D, the control circuit 200 outputs a signal to the distance sensing circuit 110 to instruct the emitting device 115 to emit light. Subsequently, when the sensor 120 senses the reflected light, the sensor 120 outputs a corresponding signal to the control circuit 200. The control circuit 200 calculates the difference between the time that emitting device 115 emitted the light and the time that the sensor 120 sensed the light. Then, based on the propagation speed of the light, the control circuit 200 is able to calculate the distance D.

Alternatively, the control circuit 200 can calculate the distance D based on the difference between the intensities of the emitted light and the sensed light. Yet alternatively, the control circuit 200 can calculate the distance D based on the difference between other characteristics (e.g., shape, polarization, etc.) of the emitted light and the sensed light.

Furthermore, the devices 115 and 120 do not need to emit and sense light to determine the distance D. For example, an not by way of limitation, sound waves or other types of propagating waves may be emitted and sensed to determine the distance D.

Also, other less sophisticated measuring devices may be used to determine the distance D. For example, a ruler, a tape measure, a string having a known length, etc. can be used to measure the distance D. If the doctor manually measures the distance D with such a device, he or she can input the distance D to the control circuit 200 via the input circuit 230. Illustrative, non-limiting examples of the input circuit 230 include a keyboard, mouse, trackball, stylus pen, touch screen interface, and voice recognition circuit.

Before or after the distance D is established, the doctor instructs the person 50 to read the groups of words 10, 20, and 30, and the time required for the person to read the groups of words 10, 20, and 30 is determined. In one example, the total time required to read all of the groups of words 10, 20, and 30 is determined. In another example, the time required to read each of the groups of words 10, 20, and 30 is measured. In yet another example, the time required to read each page or slide containing multiple groups or a portion of a group may be measured.

Clearly, one skilled in the art will readily realize that many different types of methods can be used to measure the time required to read the groups of words 10, 20, and 30. For example, one of the simplest ways to measure the time is for the doctor use a stop watch, wrist watch, or clock to time the person 50 as he or she reads the groups of words 10, 20, and 30. After the doctor measures the (1) total time required to read all of the groups or words 10, 20, and 30, (2) the time required to read each of the groups, (3) the time required to read each set of multiple groups, and/or (4) the time required to read portions of the groups, he or she may enter the measured time or times to the control circuit 200 via the input circuit 230.

In an alternative implementation, the time or times may be measured with the time sensing circuit 250 shown in FIG. 6. In the embodiment shown in FIG. 2, the time sensing circuit 250 may be electrically, optically, or mechanically coupled to the pages of the book 40. When the doctor or the person 50 turns the pages, the circuit 250 may detect the instances when the pages are turned and may output corresponding signals to the control circuit 200. Then, based on the output signals, the control circuit 200 can determine the period of time between the instances when the pages are turned. In other words, the time required to read the groups of words 10, 20, and 30 on each of the pages can be determined. Furthermore, the control circuit 220 can add all of the times required to read each of the pages to determine the total time required to read all of the groups of words 10, 20, and 30.

Also, the time sensing circuit 250 may be coupled to the projector 60 (FIG. 3), the viewing box 80 (FIG. 4), the computer 100 (FIG. 5), or the display 90 (FIG. 5) to determine the instances when a new “page” or “slide” is displayed. For example, when a button is pressed (or other input device is activated) to switch to a new “page” or “slide,” the circuit 250 may sense such occurrence and output an appropriate signal or signals to the control circuit 200. Then, the control circuit 200 may calculate the reading time or times based on the signal or signals output from the circuit 250, as described above.

Furthermore, instead of detecting a button that is pressed (or the activation of another input device) to change the “page” or “slide,” the time sensing circuit 250 may detect a separate, dedicated button (or other input device) that the person 50 or doctor presses (or activates) when the person 50 finishes reading: (1) one of the groups of words 10, 20, or 30, (2) a page, (3) a predetermined portion of one the groups of words 10, 20, or 30, and/or (4) all of the groups of words 10, 20, and 30. Then, the circuit 250 may output a corresponding signal or signals and the control circuit 200 may calculate the reading time or times, as described above.

Alternatively, the time sensing circuit 250 comprise a microphone and other circuitry to input the person's voice, perform a word recognition operation, and output data corresponding to the words that the person 50 reads aloud. Then, the control circuit 200 may compare the output data with predetermined data corresponding to the words 12, 22, and 32 within the groups of words 10, 20, and 30. By analyzing the pace or the instances at which the person 50 reads the words 12, 22, and 32, the control circuit 200 can determine the amount of time required for the person 50 to read the groups of words 10, 20, and 30. Also, instead of performing the word recognition operation within the time sensing circuit 250, the circuit 250 may output data to the control circuit 200, and the control circuit 200 may perform the word recognition operation.

Also, the accuracy with which the person 50 reads the groups of words 10, 20, and 30 could also be determined. In one example, the number words 12, 22, and 32 that the person 50 incorrectly reads with respect to all of the groups of words 10, 20, and 30 is determined. In another example, the number of words 12, 22, and 32 that the person 50 incorrectly reads with respect to each of the groups of words 10, 20, and 30 is determined. In yet another example, the number of words 12, 22, and 32 that the person 50 incorrectly reads with respect to each page or slide containing multiple groups or a portion of a group may be measured. Finally, instead of determining the number of words 12, 22, and 32 that the person 50 incorrectly reads, the number of groups that are incorrectly read or the number of pages that are incorrectly read may be determined.

One skilled in the art will readily realize that many different types of methods can be used to determine the number of words 12, 22, and 32, groups of words 10, 20, and 30, or pages that the person 50 incorrectly reads. For instance, one of the simplest ways to determine the number of errors is for the doctor to manually keep track of the errors. After the doctor determines the (1) number of misread words within each group of words 10, 20, and 30, (2) the total number of misread words with respect to all of the groups or words 10, 20, and 30, (3) the number of misread groups with respect to all of the groups or words 10, 20, and 30, (4) the number of misread pages with respect to the total number of pages, (5) etc., he or she may enter the number of errors to the control circuit 200 via the input circuit 230.

In an alternative implementation, the doctor may use the reading accuracy sensing circuit 260 shown in FIG. 6 to determine the errors. In one implementation, the circuit 260 comprises a button or other input device, and each time the person 50 misreads a word, group, and/or page, the doctor presses the button (or activates another input device). Then, the circuit 260 outputs a corresponding signal or signals to the control circuit 200.

Alternatively, the circuit 260 may comprise a microphone and other circuitry to input the person's voice, perform a word recognition operation, and output data corresponding to the words that the person 50 reads aloud. Then, the control circuit 200 may compare the output data with predetermined data corresponding to the words 12, 22, and 32 within the groups of words 10, 20, and 30 to determine errors in reading the words, groups, and/or pages. Also, instead of performing the word recognition operation within the reading accuracy sensing circuit 260, the circuit 260 may output data to the control circuit 200, and the control circuit 200 may perform the word recognition operation to determine the number of errors.

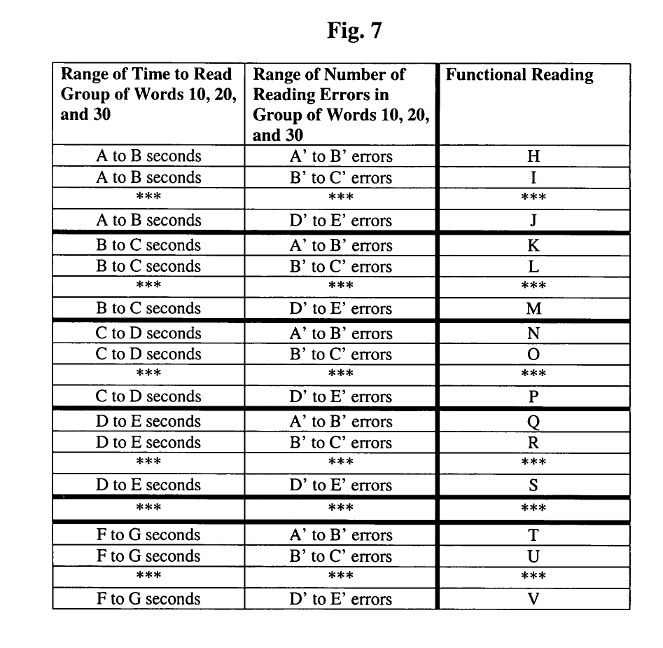

After the control circuit 200 obtains the number of reading errors that the person 50 made, the time that the person 50 needed to read the words, groups, pages, etc., and the distance D (if not predetermined) between the person 50 and the groups of words 10, 20, and 30, the control circuit 200 determines the functional reading speed or functional reading vision of the person 50. In one implementation, the control circuit 200 may determine the functional reading vision of a patient in accordance with predetermined equation that is a function of the number of errors, the reading time or times, the distance D (if necessary), and the other factors mentioned above and below. Alternatively, the control circuit 200 may use the above data and make the determinations above based on a look up table. The look up table may be stored in the memory 220 of the control circuit 200, and an illustrative, non-limiting example of the look up table is shown in FIG. 7.

In the look up table, the control circuit assumes that the distance D between the person 50 and the groups of words 10, 20, and 30 is constant. Also, as shown in the table, if the person 50 reads the groups of words 10, 20, and 30 between A and B seconds and if the person 50 makes between B′ and C′ reading errors, the person's functional reading vision is “I.” On the other hand, if the person 50 reads the groups of words 10, 20, and 30 between F and G seconds and if the person 50 makes between B′ and C′ errors, the person's functional reading vision is “U.” Also, the control circuit 220 may optionally display the results of its determinations on the display 240.

Additional inputs to the look up table may be added to enhance or refine the analysis that the control circuit 200 performs. For example, a twenty year old person 50 having relatively good vision (for his or her age) should be able to read paragraphs with small print quickly. On the other hand, a 75 year old person 50 having relatively good vision (for his or her age) may have difficulty reading any small print and may only be able to read larger words. Thus, there may be different acceptable ranges of reading time and different acceptable ranges of the number of reading errors for a person 50, depending on his or her age. Therefore, the look up table may include a person's age as another input variable to the table, and the control circuit 200 may assess the person's functional reading vision in terms of how good his or her vision is in comparison to other people having the same or similar ages. For example, if the person is 75 years old, the control circuit 200 may determine that the person's functional reading vision is in the top ten percentile for 75 year olds. Furthermore, the doctor can supply data relating to the person's age to the control circuit 200 via the input circuit 230.

In addition, as shown in FIG. 7, the look up table merely evaluates the number of total reading errors in all of the groups of words 10, 20, and 30. However, as described above, the look up table may include additional input criteria, which relate to (for example) the number of errors corresponding to each individual group of words 10, 20, or 30 and/or the number of errors corresponding to each page of words.

Similarly, the look up table merely evaluates the total time required to read all of the groups of words 10, 20, and 30. However, the look up table may include additional input criteria, which relate to (for example) the time required to read each individual group of words 10, 20, or 30 and/or the number of errors corresponding to each page of words.

Furthermore, as mentioned above, the reading speed of the groups of words 10, 20, and 30 and/or the number of reading errors may change based on the racial, social, economic, educational, and other statuses of the person 50 reading the groups. Therefore, additional criteria may be added to the table that relate to one or more of the statuses of the person 50. The doctor may supply this information to the control circuit 200 via the input circuit 230.

Also, instead of using the control circuit 200, the doctor may manually determine the person's functional reading vision by referring to a hard copy of a table or by performing the appropriate calculations.

The specific entries within the look up table and/or the specific equations that the control circuit 200 or doctor solves may be empirically refined, as data, which relates to the time required for various groups of people to accurately read paragraphs of different sizes, is collected. Nonetheless, one skilled in the art, upon reading the present specification, would know which values to include in the look up table and how to formulate an appropriate equation for determining the severity of the person's vision problem, the suggested type of treatment, and the suggested degree of treatment.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents thereof.

What is claimed is:

1. A method of assessing a vision characteristic of a person, comprising:
(a) presenting at least a first group of words via a medium;
(b) determining a reading speed at which the person reads at least the first group of words from the medium; and
(c) assessing the vision characteristic based on the reading speed.

2. The method as claimed in claim 1, further comprising:
(d) determining a reading accuracy with which the person reads the first group of words,
wherein the operation (c) comprises:
(c1) assessing the vision characteristic based on the reading speed and the reading accuracy.

3. The method as claimed in claim 1, wherein the operation (b) comprises:
(b1) determining the reading speed at which the person reads at least the first group of words and a second group of words from the medium.

4. The method as claimed in claim 3, wherein a characteristic of the first group of words is different than the characteristic of the second group of words.

5. The method as claimed in claim 4, wherein the characteristic comprises one of font type, font size, font style, spacing, font color, and background color.

6. The method as claimed in claim 3, wherein a subject matter of the first group of words is related to a subject matter of the second group of words.

7. The method as claimed in claim 3, wherein a subject matter of the first group of words is not related to a subject matter of the second group of words.

8. The method as claimed in claim 1, wherein a subject matter of the first group of words is tailored for people having a particular status.

9. The method as claimed in claim 8, wherein the particular status comprises at least one of particular racial, social, economic, and educational statuses.

10. The method as claimed in claim 3, wherein a subject matter of the first group of words is tailored for people having a first status and a subject matter of the second group of words is tailored for people having a second status.

11. The method as claimed in claim 10, wherein the first status comprises at least one of first racial, social, economic, and educational statuses and the second status comprises at least one of second racial, social, economic, and educational statuses.

12. The method as claimed in claim 3, wherein the medium comprises a book containing the first group of words and the second group of words.

13. The method as claimed in claim 3, wherein the medium comprises at least one sheet of paper containing the first group of words and the second group of words

14. The method as claimed in claim 3, wherein the medium comprises a surface on which a projector projects the first group of words and the second group of words.

15. The method as claimed in claim 3, wherein the medium comprises a screen of a viewing box presenting the first group of words and the second group of words.

16. The method as claimed in claim 3, wherein the medium comprises a display that displays the first group of words and the second group of words.

17. The method as claimed in claim 3, wherein operation (c) comprises:
(c1) assessing the vision characteristic based on a distance between the medium and the person.

18. The method as claimed in claim 17, wherein the distance is a fixed distance.

19. The method as claimed in claim 17, wherein the operation (c1) comprises:
(c1a) measuring the distance between the person and the medium.

20. The method as claimed in claim 19, wherein operation (c1a) comprises:
(c1a1) measuring the distance between the person and the medium via a distance measuring circuit.

21. The method as claimed in claim 20, wherein the distance measuring circuit comprises:
an emitting circuit that emits a wave that reflects off one of a location where the person is located and a location where the medium is located to produce a corresponding reflected wave; and
a sensing circuit that receives the reflected wave,
wherein a difference between a first characteristic of the wave and a second characteristic of the reflected wave is used to determine the distance.

22. The method as claimed in claim 21, wherein the first characteristic of the wave corresponds to a time at which the emitting circuit emits the wave, and
wherein the second characteristic of the wave corresponds to a time at which the sensing circuit receives the reflected wave.

23. The method as claimed in claim 21, further comprising:
(d) using a control circuit to determine the difference between the first characteristic of the wave and the second characteristic of the reflected wave and to calculate the distance based on the difference,
wherein the operation (c1) comprises:
(c1a) determining the vision characteristic via the control circuit.

24. The method as claimed in claim 19, further comprising:
(d) inputting the measured distance to a control circuit, wherein the operation (c1) comprises:
(c1a) determining the vision characteristic via the control circuit.

25. The method as claimed in claim 3, wherein the operation (b) comprises:
(b1) measuring at least one time to read the first group of words and the second group of words; and
(b2) determining the reading speed based on at least the one time.

26. The method as claimed in claim 25, wherein the operation (b2) comprises:
(b2a) inputting at least the one time to a control circuit, wherein at least the one time corresponds to the reading speed, and
wherein operation (c) comprises
(c1) using the control circuit to determine the vision characteristic based on the reading speed.

27. The method as claimed in claim 3, wherein the operation (b) comprises:
(b1) determining at least one time to read at least the first group of words and the second group of words via a time sensing circuit, wherein at least the one time corresponds to the reading speed, and
wherein the operation (c) comprises
(c1) using a control circuit to determine the vision characteristic based on the reading speed.

28. The method as claimed in claim 27, wherein the medium comprises a book, and
wherein time sensing circuit comprises a page turning sensing circuit that senses when a page of the book is turned.

29. The method as claimed in claim 27, wherein the medium comprises a surface,
wherein the first group of words and the second group of words are contained on at least one slide of a group of slides that is presented on the surface, and
wherein time sensing circuit comprises a slide changing sensing circuit that senses when a slide in the group of slides is changed.

30. The method as claimed in claim 29, wherein the surface comprises one of a screen of a display, a surface on which a projector projects at least the one slide, and a viewing surface of a viewing box.

31. The method as claimed in claim 27, wherein time sensing circuit comprises an input device that an administrator activates when the person finishes reading at least one of (1) the first group of words and (2) the first group of words and the second group of words.

32. The method as claimed in claim 3, wherein the operation (b) comprises:
(b1) using a voice recognition circuit to recognize words of the first group of words and the second group of words that the person reads;
(b2) determining the reading speed via voice recognition circuit, and
wherein the operation (c) comprises:
(c1) using a control circuit to determine the vision characteristic based on the reading speed.

33. The method as claimed in claim 2, wherein the operation (d) comprises:
(d1) determining reading errors when the person reads the first group of words and determining the reading accuracy based on the reading errors.

34. The method as claimed in claim 33, wherein the operation (d1) comprises:
(d1a) inputting the number of reading errors to a control circuit to determine the reading accuracy.

35. The method as claimed in claim 33, wherein the operation (d1) comprises:
(d1a) determining the reading errors via a reading accuracy sensing circuit.

36. The method as claimed in claim 35, wherein the operation (d1a) comprises:
(d1a1) activating an input device on the reading accuracy sensing circuit each time the person misreads a word.

37. The method as claimed in claim 36, wherein the operation (d1a) further comprises:
(d1a2) generating a sensing signal when the input device is activated; and
(d1a3) outputting the sensing signal to a control circuit to determine the reading accuracy.

38. The method as claimed in claim 35, wherein the reading accuracy sensing circuit comprises a word recognition circuit that recognizes read words that the person reads, and
wherein the operation (d1a) comprises:
(d1a1) using a control circuit that compares the read words with the words in the first group of words to determine the reading accuracy.

39. The method as claimed in claim 2, wherein the operation (d) comprises:
(d1) inputting the reading speed and the reading accuracy to a control circuit,
wherein the operation (c1) comprises:
(c1a) using the control circuit to determine the vision characteristic based on the reading speed and the reading accuracy.

40. The method as claimed in claim 39, wherein the operation (c1a) comprises:
(c1a1) using the control circuit to calculate the vision characteristic via predetermined equation based on the reading speed and the reading accuracy.

41. The method as claimed in claim 40, wherein the predetermined equation is further based on a distance between the person and the medium presenting the first group of words.

42. The method as claimed in claim 40, wherein the predetermined equation is further based on an age of the person.

43. The method as claimed in claim 40, wherein the predetermined equation is further based on at least one of racial, social, economic, and educational statuses of the person.

44. The method as claimed in claim 39, wherein operation (c1a) comprises:
(c1a1) using the control circuit to determine the vision characteristic via look up table,
wherein inputs of the look up table comprise the reading speed and the reading accuracy.

45. The method as claimed in claim 44, wherein the inputs of the look up table further comprise a distance between the person and the medium presenting the first group of words, and
wherein the control circuit determines the vision characteristic based on the distance.

46. The method as claimed in claim 44, wherein the inputs of the look up table further comprise an age of the person, and
wherein the control circuit determines the vision characteristic based on the age.

47. The method as claimed in claim 44, wherein the inputs of the look up table further comprise at least one of racial, social, economic, and educational statuses of the person, and
wherein the control circuit determines the vision characteristic based on at least one of the racial, social, economic, and educational statuses.

48. The method as claimed in claim 2, wherein operation (c1) comprises:
(c1a) assessing the vision characteristic further based on a distance between the person and the medium presenting the first group of words.

49. The method as claimed in claim 2, wherein operation (c1) comprises:
(c1a) assessing the vision characteristic further based on an age of the person.

50. The method as claimed in claim 2, wherein operation (c1) comprises:
(c1a) assessing the vision characteristic further based on at least one of racial, social, economic, and educational statuses of the person.

51. An apparatus for assessing a vision characteristic of a person, comprising:
an input circuit that generates a reading speed signal corresponding to a reading speed at which the person reads at least a first group of words from a medium; and
a control circuit that determines the vision characteristic based on the reading speed.

52. The apparatus as claimed in claim 51, wherein the input circuit generates a reading accuracy signal based on a reading accuracy with which the person reads the first group of words, and
wherein the control circuit determines the vision characteristic based on the reading speed and the reading accuracy.

53. The apparatus as claimed in claim 51, wherein the medium comprises a book containing the first group of words.

54. The apparatus as claimed in claim 51, wherein the medium comprises at least one sheet of paper containing the first group of words.

55. The apparatus as claimed in claim 51, wherein the medium comprises a surface on which a projector projects the first group of words.

56. The apparatus as claimed in claim 51, wherein the medium comprises a screen of a viewing box presenting the first group of words.

57. The apparatus as claimed in claim 51, wherein the medium comprises a display that displays the first group of words.

58. The apparatus as claimed in claim 51, wherein the control circuit assesses the vision characteristic based on a distance between the medium and the person.

59. The apparatus as claimed in claim 58, wherein the distance is a fixed distance.

60. The apparatus as claimed in claim 58, wherein the input circuit generates a distance signal corresponding to the distance between the person and the medium, and
wherein the control circuit assesses the vision characteristic based on the distance signal.

61. The apparatus as claimed in claim 60, wherein the input circuit comprises a distance measuring circuit that measures the distance between the person and the medium.

62. The apparatus as claimed in claim 61, wherein the distance measuring circuit comprises:
an emitting circuit that emits a wave that reflects off one of a location where the person is located and a location where the medium is located to produce a corresponding reflected wave; and
a sensing circuit that receives the reflected wave and that generates the distance signal, which is based on a difference between a first characteristic of the wave and a second characteristic of the reflected wave.

63. The apparatus as claimed in claim 62, wherein the first characteristic of the wave corresponds to a time at which the emitting circuit emits the wave, and
wherein the second characteristic of the wave corresponds to a time at which the sensing circuit receives the reflected wave.

64. The apparatus as claimed in claim 60, wherein an administrator inputs a measured distance to the input circuit, and
wherein the input circuit generates the distance signal based on the measured distance.

65. The apparatus as claimed in claim 51, wherein an administrator inputs a time required for the person to read the first group of words to the input circuit, and
wherein the input circuit generates the reading speed signal based on the time.

66. The apparatus as claimed in claim 51, wherein the input circuit comprises a time sensing circuit that senses a time required for the person to read the first group of words, and
wherein the input circuit generates the reading speed signal based on the time.

67. The apparatus as claimed in claim 66, wherein the medium comprises a book,
wherein the time sensing circuit comprises a page turning sensing circuit that senses when a page of the book is turned, and
wherein the time sensing circuit determines the time based on when the page is turned.

68. The apparatus as claimed in claim 66, wherein the medium comprises a surface,
wherein the first group of words are contained on at least one slide of a group of slides that is presented on the surface,
wherein time sensing circuit comprises a slide changing circuit that senses when a slide in the group of slides is changed, and
wherein the time sensing circuit determines the time based on when the slide is changed.

69. The apparatus as claimed in claim 68, wherein the surface comprises one of a screen of a display, a surface on which a projector projects the at least one slide, and a viewing surface of a viewing box.

70. The apparatus as claimed in claim 51, wherein the input circuit comprises a voice recognition circuit that recognizes words of the first group of words that the person reads, and
wherein the voice recognition circuit generates the reading speed signal based on a rate at which the person reads the words.

71. The apparatus as claimed in claim 52, wherein an administrator inputs, to the input circuit, a number of reading errors that the person makes when the person reads the first group of words, and
wherein the input circuit generates the reading accuracy signal based on the reading errors.

72. The apparatus as claimed in claim 52, wherein the administrator activates an input device on the input circuit each time the person misreads a word, and
wherein the input circuit generates the reading accuracy signal based on an activation of the input device.

73. The apparatus as claimed in claim 52, wherein the input device comprises a word recognition circuit that recognizes read words that the person reads, and
wherein the input circuit compares the read words with the words in the first group of words to determine the reading accuracy, and
wherein the input circuit generates the reading accuracy signal based on the reading accuracy.

74. The apparatus as claimed in claim 52, wherein the control circuit calculates the vision characteristic via predetermined equation based on the reading speed and the reading accuracy.

75. The apparatus as claimed in claim 74, wherein the predetermined equation is further based on a distance between the person and the medium presenting the first group of words.

76. The apparatus as claimed in claim 74, wherein the predetermined equation is further based on an age of the person.

77. The apparatus as claimed in claim 74, wherein the predetermined equation is further based on at least one of racial, social, economic, and educational statuses of the person.

78. The apparatus as claimed in claim 52, wherein the control circuit determines the vision characteristic via look up table,
wherein inputs of the look up table comprise the reading speed and the reading accuracy.

79. The apparatus as claimed in claim 78, wherein the inputs of the look up table further comprise a distance between the person and the medium presenting the first group of words, and
wherein the control circuit determines the vision characteristic based on the distance.

80. The apparatus as claimed in claim 78, wherein the inputs of the look up table further comprise an age of the person, and
wherein the control circuit determines the vision characteristic based on the age.

81. The apparatus as claimed in claim 78, wherein the inputs of the look up table further comprise at least one of racial, social, economic, and educational statuses of the person, and
wherein the control circuit determines the vision characteristic based on at least one of the racial, social, economic, and educational statuses.

82. The apparatus as claimed in claim 52, wherein the control circuit assesses the vision characteristic further based on a distance between the person and the medium presenting the first group of words.

83. The apparatus as claimed in claim 52, wherein the control circuit assesses the vision characteristic further based on an age of the person.

84. The apparatus as claimed in claim 52, wherein the control circuit assesses the vision characteristic further based on at least one of racial, social, economic, and educational statuses of the person.

85. The method as claimed in claim 5, wherein the characteristic comprises font type.

86. The method as claimed in claim 5, wherein the characteristic comprises font size.

87. The method as claimed in claim 5, wherein the characteristic comprises font style.

88. The method as claimed in claim 5, wherein the characteristic comprises spacing.

89. The method as claimed in claim 5, wherein the characteristic comprises font color.

90. The method as claimed in claim 5, wherein the characteristic comprises background color.

91. The apparatus as claimed in claim 51, wherein the input circuit generates the reading speed signal corresponding to the reading speed at which the person reads at least the first group of words and a second group of words from the medium,
wherein a characteristic of the first group of words is different than the characteristic of the second group of words.

92. The apparatus as claimed in claim 91, wherein the characteristic comprises one of font type, font size, font style, spacing, font color, and background color.

93. The apparatus as claimed in claim 92, wherein the characteristic comprises font type.

94. The apparatus as claimed in claim 92, wherein the characteristic comprises font size.

95. The apparatus as claimed in claim 92, wherein the characteristic comprises font style.

96. The apparatus as claimed in claim 92, wherein the characteristic comprises spacing.

97. The apparatus as claimed in claim 92, wherein the characteristic comprises font color.

98. The apparatus as claimed in claim 92, wherein the characteristic comprises background color.
